(19) United States
(12) Patent Application Publication
(10) Pub. No.: US 2022/0247631 A1
(43) Pub. Date: Aug. 4, 2022

(54) NETWORK MANAGEMENT APPARATUS AND METHOD

(71) Applicant: Nippon Telegraph and Telephone Corporation, Tokyo (JP)

(72) Inventors: Shohei Nishikawa, Musashino-shi, Tokyo (JP); Masataka Sato, Musashino-shi, Tokyo (JP); Kenichi Tayama, Musashino-shi, Tokyo (JP); Shingo Horiuchi, Musashino-shi, Tokyo (JP); Kenji Murase, Musashino-shi, Tokyo (JP); Kimihiko Fukami, Musashino-shi, Tokyo (JP)

(21) Appl. No.: 17/614,192

(22) PCT Filed: May 28, 2019
(86) PCT No.: PCT/JP2019/021138

§ 371 Date: Nov. 24, 2021

(51) Int. Cl. H04L 41/0816; H04L 41/08; H04L 41/084

(52) U.S. Cl. CPC H04L 41/0816; H04L 41/0846; H04L 41/0883

(57) ABSTRACT

A network management device according to an aspect includes a processing circuitry configured to perform acquiring a network configuration of a logical layer concerning a communication network having a redundant configuration in a communication section between a first network device and a second network device, the network configuration being a network configuration of a logical layer including a plurality of logical entities including a first logical entity corresponding to a first virtual port set in the first network device and a second logical entity corresponding to a second virtual port set in the second network device and, in response to occurrence of a failure of the communication network, retrieving a communicable path leading from the first logical entity to the second logical entity.

### TECHNICAL FIELD

Aspects of the present invention relate to a technique for managing a communication network.

### BACKGROUND ART

In recent years, various services using a communication network configured by a plurality of network devices have been provided. When a failure of a communication network occurs because of a disaster, a breakdown of an apparatus, or the like, communication companies providing such network services have to accurately and quickly grasp the influence of the failure on a failed network service. However, when a network is managed by an operation support system different for each physical or logical layer, it is difficult to grasp network failure influence across layers.

Incidentally, there has been known a network management architecture that makes it possible to manage a network without relying on types of a network device and a communication protocol. For example, a network management architecture disclosed in Non-Patent Literature 1 makes it possible to model a configuration of a network in which different operation support systems manage physical and logical layers.

### CITATION LIST

### Non-Patent Literature

Non-Patent Literature 1: Masamune Sato and other three, “Study of NW Management Architecture Applicable to Various NWs”, IEICE technical report, vol. 116. No. 324, ICM2016-31, pp. 37-42, November 2016

### SUMMARY OF THE INVENTION

### Technical Problem

In general, a communication network takes a redundant configuration in which a plurality of communication paths are present. When a failure occurs in the communication network that takes the redundant configuration, it is necessary to determine about a certain network communication section whether all paths are in an uncommunicable state or a certain path is uncommunicable but the other paths are in a communicable state. In this specification, a state in which all paths are uncommunicable in a network communication section is referred to as entirely disconnected and a state in which one or a plurality of paths are uncommunicable but the other paths are communicable in the network communication section is referred to as partially path disconnected.

Conventionally, a human operator determines whether the network communication section is entirely disconnected or partially path disconnected referring to network configuration information. Accordingly, there is a problem in that work operation of the operator increases and it takes time to grasp communicability in the network communication section during failure occurrence.

The present invention has been made in view of the circumstances described above, and an object of the present invention is to provide a technique for making it possible to reduce work operation of an operator and quickly grasp communicability in a network communication section during failure occurrence.

### Means for Solving the Problem

A network management device according to an aspect of the present invention includes a processing circuitry configured to perform: acquiring a network configuration of a logical layer concerning a communication network having a redundant configuration in a communication section between a first network device and a second network device, the network configuration being a network configuration of a logical layer including a plurality of logical entities including a first logical entity corresponding to a first virtual port set in the first network device and a second logical entity corresponding to a second virtual port set in the second network device; and, in response to occurrence of a failure of the communication network, retrieving a communicable path leading from the first logical entity to the second logical entity.

### Effects of the Invention

According to the present invention, it is possible to provide a technique for making it possible to reduce work operation of an operator and quickly grasp communicability in a network communication section during failure occurrence.

### BRIEF DESCRIPTION OF DRAWINGS

FIG. 1 is a block diagram illustrating a network management device according to an embodiment.

FIG. 2 is diagram illustrating an entity definition according to the embodiment.

FIG. 3 is a diagram illustrating the configuration of a communication network according to the embodiment.

FIG. 4 is a diagram for explaining a failure influence grasping method according to a comparative example.

FIG. 5 is a block diagram illustrating a hardware configuration of the network management device shown in FIG. 1.

FIG. 6 is a flowchart illustrating a failure influence grasping method executed by the network management device shown in FIG. 1.

FIG. 7 is a flowchart illustrating the failure influence grasping method executed by the network management device shown in FIG. 1.

FIG. 8 is a flowchart illustrating the failure influence grasping method executed by the network management device shown in FIG. 1.

FIG. 9 is a diagram for explaining a failure influence grasping method according to the embodiment.

FIG. 10 is a diagram for explaining the failure influence grasping method according to the embodiment.

FIG. 11 is a diagram for explaining the failure influence grasping method according to the embodiment.

FIG. 12 is a diagram for explaining the failure influence grasping method according to the embodiment.

FIG. 13 is a diagram for explaining the failure influence grasping method according to the embodiment.

FIG. 14 is a diagram for explaining the failure influence grasping method according to the embodiment.

FIG. 15 is a diagram for explaining the failure influence grasping method according to the embodiment.

### DESCRIPTION OF EMBODIMENTS

An embodiment of the present invention is explained below with reference to the drawings.

[Configuration]

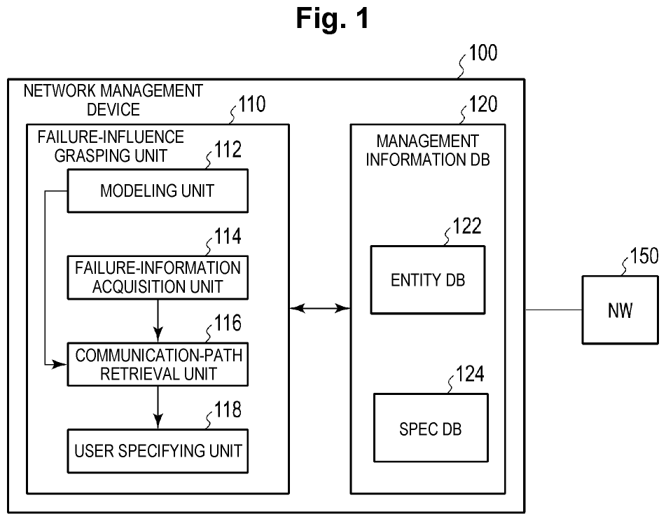

FIG. 1 schematically illustrates a network management device 100 according to an embodiment. The network management device 100 shown in FIG. 1 manages a communication network 150 including a plurality of network devices. The communication network 150 is used to, for example, provide a network service. The network management device 100 is implemented by a computer such as a server. The network management device 100 includes a failure-influence grasping unit 110 and a management information database (DB) 120.

The management information DB 120 stores network management information for managing the communication network 150. This embodiment adopts a network management architecture in which a connection relation in a physical layer, a connection relation in a logical layer, and a connection relation between the layers are managed in specifications and entities. This architecture makes it possible to represent configurations of various communication networks in a unified form. The management information DB 120 includes an entity database (DB) 122 and a spec database (DB) 124.

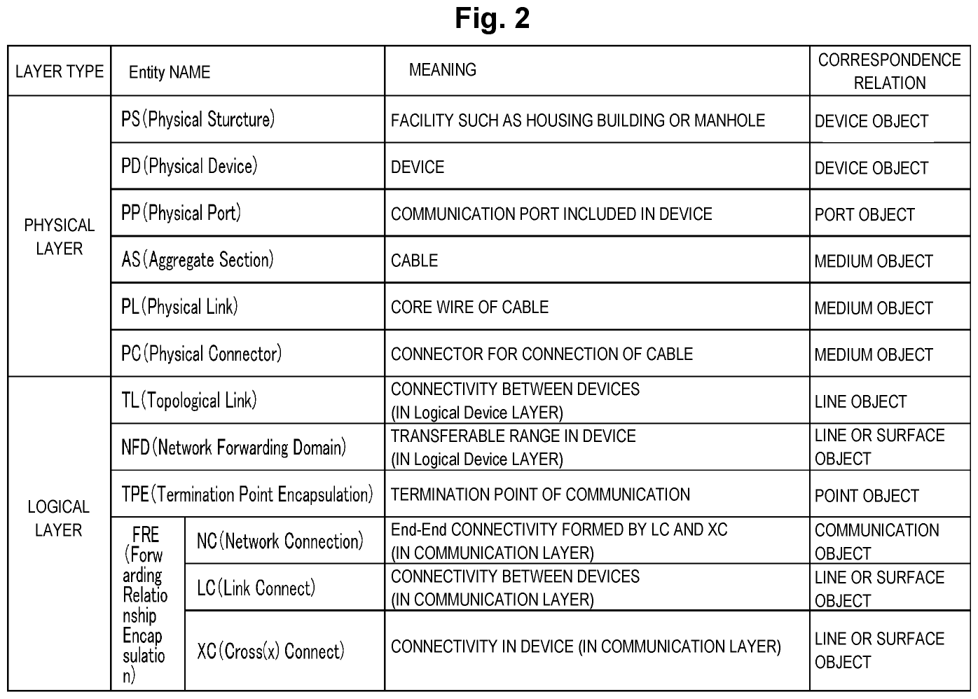

The entity DB 122 stores entity classes, which are information concerning entities of the physical layer and the logical layer. The entity classes include information indicating names and attributes of the entities. As shown in FIG. 2, as the entity names, PS (Physical Structure), PD (Physical Device), PP (Physical Port), AS (Aggregate Section), PL (Physical Link), PC (Physical Connector), TL (Topological Link), NFD (Network Forwarding Domain), TPE (Termination Point Encapsulation), FRE (Forwarding Relationship Encapsulation), NC (Network Connection), LC (Link Connect), and XC (Cross Connect) are defined. PS, PD, PP, AS, PL, and PC relate to the physical layer. TL, NFD, TPE FRE, NC, LC, and XC relate to the logical layer.

PS represents a facility such as a building or a manhole. PD represents a device. PP represents a communication port included in the device. AS represents a cable. PL represents a core wire of the cable. PC represents a connector for connection of the cable. TL represents connectivity between devices. NFD represents a transferable range in the device. TPE represents a termination point of communication. LC represents connectivity between devices in a communication layer. XC represents connectivity in the device in the communication layer. NC represents end-to-end (End-End) connectivity formed by LC or XC. FRE is a general term of NC, LC, and XC.

The PS entity has, for example, status, pdList, asList, and position attributes. The status attributes is an attribute indicating a state of the PS entity. The status attribute has a true value indicating a normal state and a false value indicating a broken state. The pdList attribute is an attribute indicating the PD entity included in the PS entity. The asList attribute is an attribute indicating the AS entity included in the PS entity. The position attribute is an attribute indicating the position of the PS entity. The position attribute has a two-dimensional coordinate value representing a position.

The PD entity has, for example, status, ppList, and position attributes. The status attribute is an attribute indicating a state of the PD entity. The ppList attribute is an attribute indicating the PP entity included in the PD entity. The position attribute is an attribute indicating the position of the PD entity.

The PP entity has, for example, status and position attributes. The status attribute is an attribute indicating a state of the PP entity. The position attribute is an attribute indicating the position of the PP entity.

The AS entity has, for example, status, plList, and position attributes. The status attribute is an attribute indicating a state of the AS entity. The plList attribute is an attribute indicating the PL entity included in the AS entity. The position attribute is an attribute indicating the position of the AS entity.

The PL entity has, for example, status and pcList attributes. The status attribute is an attribute indicating a state of the PL entity. The pcList attribute is an attribute indicating the PC entity included in the PL entity.

The PC entity has, for example, status and ppList attributes. The status attribute is an attribute indicating a state of the PC entity. The ppList attribute is an attribute indicating the PP entity included in the PC entity.

The TL entity has, for example, status and endPointList attributes. The status attribute is an attribute indicating a state of the TL entity. The endPointList attribute is an attribute indicating the TPE entity configuring the TL entity.

The NFD entity has, for example, status and endPointList attributes. The status attribute is an attribute indicating a state of the NFD entity. The endPointList attribute is an attribute indicating the TPE entity configuring the NFD entity.

The TPE entity has, for example, status, tpeRefList, ppRefList, and layername attributes. The status attribute is an attribute indicating a state of the TPE entity. The tpeRefList attribute is an attribute indicating the TPE entity of a high-order layer and/or a low-order layer corresponding to the TPE entity. The ppRefList attribute is an attribute indicating the PP entity corresponding to the TPE entity. The layername attribute is an attribute indicating a name of a layer to which the TPE entity belongs.

The NC entity has, for example, status, endPointList, userList, and layername attributes. The status attribute is an attribute indicating a state of the NC entity. The endPointList attribute is an attribute indicating the TPE entity configuring the NC entity. The userList attribute is an attribute indicating a user name or indicating a URL (Uniform Resource Locator) of an interface for acquiring the user name. The user name is, for example, a name of a user subscribing to the network service. The layername attribute is an attribute indicating a name of a layer to which the NC entity belongs.

The LC entity has, for example, status, endPointList, and layername attributes. The status attribute is an attribute indicating a state of the LC entity. The endPointList attribute is an attribute indicating the TPE entity configuring the LC entity. The layername attribute is an attribute indicating a name of a layer to which the LC entity belongs.

The XC entity has, for example, status, endPointList, and layername attributes. The status attribute is an attribute indicating a state of the XC entity. The endPointList attribute is an attribute indicating the TPE entity configuring the XC entity. The layername attribute is an attribute indicating a name of a layer to which the XC entity belongs.

As explained above, the PS entity has the plList attribute and the asList attribute, the PD entity and the PC entity have the ppList attribute, the AS entity has the plList attribute, the PL entity has the pcList attribute, the TL entity, the NFD entity, the NC entity, the LC entity, and the XC entity have the endPointList attribute, and the TPE entity has the tpeRefList attribute and the ppRefList attribute. Consequently, when a failure of any physical structure (for example, a network device or a building) occurs, it is possible to specify entities affected by the failure. Further, the NC entity has the userList attribute. Consequently, it is possible to specify users affected by the failure.

Referring back to FIG. 1, the spec DB 124 stores specification classes associated with entity classes. The specification classes include information indicating specific attributes relying on types of network devices and/or communication protocols.

The network management architecture adopted by this embodiment makes it possible to manage the communication network 150 with a unified logic even when the communication network 150 is a communication network in which different operation support systems manage physical and logical layers.

When a failure occurs in the communication network 150, the failure-influence grasping unit 110 grasps the influence of the failure on services. The failure-influence grasping unit 110 includes a modeling unit 112, a failure-information acquisition unit 114, a communication-path retrieval unit 116, and a user specifying unit 118.

The modeling unit 112 models the communication network 150 according to the network management information stored in the management information DB 120 and generates a network configuration of the logical layer. The communication network 150 has a redundant configuration in a communication section between a first network device and a second network device. The redundant configuration indicates a configuration in which a plurality of communication paths are present. The first network device and the second network device are devices for which communicability in a communication section between the first network device and the second network device is determined. The modeling unit 112 performs the modeling after respectively setting a first virtual port and a second virtual port in the first network device and the second network device. Consequently, the network configuration of the logical layer includes a first logical entity and a second logical entity respectively corresponding to the first virtual port and the second virtual port.

The failure-information acquisition unit 114 acquires, from a not-shown computer (for example, server), failure information indicating that a failure has occurred in the communication network 150. The failure information includes information indicating a physical structure in which the failure has occurred (for example, a collapsed building). The failure-information acquisition unit 114 generates related path information and breakdown resource information based on the acquired failure information and the network configuration of the logical layer generated by the modeling unit 112. The related path information indicates a related range of failure parts (a range of the network configuration of the logical layer corresponding to the failure parts). The related path information can be, for example, an array having, as elements, identifiers for specifying respective entities included in the related range of the failure parts. The breakdown resource information indicates a breakdown resource, which is a logical entity disabled according to a failure. Specifically, the breakdown resource is an entity included in the related range of the failure parts. For example, the failure-information acquisition unit 114 obtains the breakdown resource information by merging elements other than an element corresponding to the NC entity of the array, which is the related path information. Further, the failure-information acquisition unit 114 adds the element corresponding to the NC entity to the breakdown resource information. Consequently, the breakdown resource information retains elements without redundancy.

In order to determine the communicability in the communication section between the first network device and the second network device, the communication-path retrieval unit 116 retrieves, about the network configuration of the logical layer, a communicable path leading from the first logical entity to the second logical entity. When a communicable path leading from the first logical entity to the second logical entity is present, the communication-path retrieval unit 116 determines that the communication section is communicable. When a communicable path leading from the first logical entity to the second logical entity is absent, the communication-path retrieval unit 116 determines that the communication section is uncommunicable.

The user specifying unit 118 specifies, based on an output of the communication-path retrieval unit 116, users affected by a network failure. For example, when the first network device is a service providing side and the communication section between the first network device and the second network device becomes uncommunicable, the user specifying unit 118 specifies users associated with the second network device referring to the network management information stored in the management information DB 120. The user specifying unit 118 may calculate the number of users affected by the network failure.

The network management device 100 having the configuration explained above can grasp a network communication section that becomes uncommunicable because of the network failure and the number of users affected by the network failure.

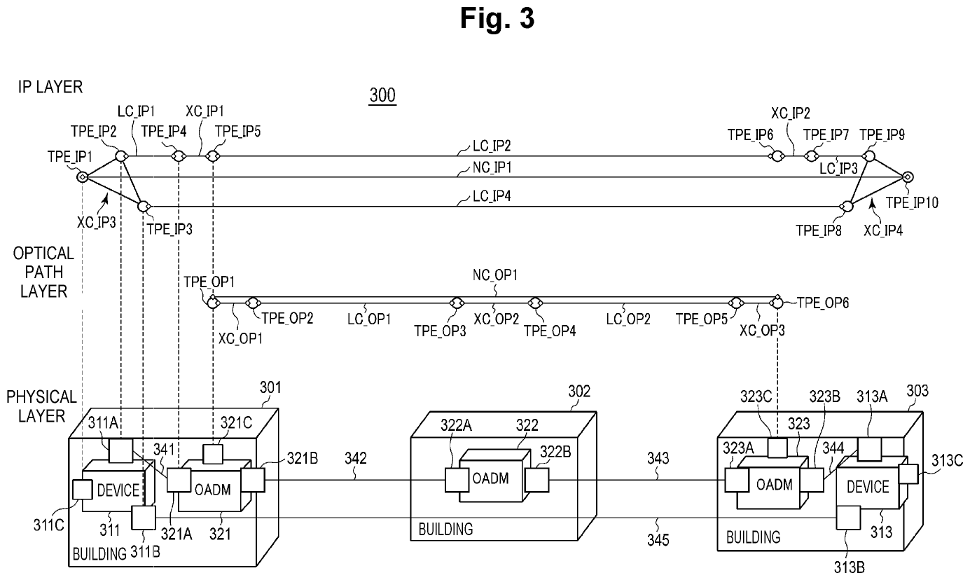

FIG. 3 illustrates the configuration of a communication network 300 according to the embodiment. The communication network 300 shown in FIG. 3 is an example of the communication network 150 shown in FIG. 1.

As shown in FIG. 3, the communication network 300 includes devices 311 and 313, OADMs (Optical Add-Drop Multiplexers) 321 to 323, and cables 341 to 345. The device 311 and the OADM 321 are housed in a building 301, the OADM 322 is housed in a building 302, and the device 313 and the OADM 323 are housed in a building 303. The cables 341 and 344 are, for example, LAN (Local Area Network) cables. The cables 342 and 343 are, for example, optical path cables such as single-mode optical fibers. The cable 345 is, for example, a cable obtained by binding core wires. The buildings 301 to 303 and the cables 341 to 345 are examples of facilities. The devices 311 and 313 and the OADMs 321 to 323 are examples of network devices. The devices 311 and 313 can be routers.

The device 311 includes physical ports 311A and 311B. The device 313 includes physical ports 313A and 313B. The OADM 321 includes physical ports 321A and 321B. The OADM 322 includes physical ports 322A and 322B. The OADM 323 includes physical ports 323A and 323B.

The physical port 311A of the device 311 is connected to the physical port 321A of the OADM 321 by the cable 341. The physical port 321B of the OADM 321 is connected to the physical port 322A of the OADM 322 by the cable 342. The physical port 322B of the OADM 322 is connected to the physical port 323A of the OADM 323 by the cable 343. The physical port 323B of the OADM 323 is connected to the physical port 313A of the device 313 by the cable 344. The physical port 311B of the device 311 is connected to the physical port 313B of the device 313 by the cable 345.

An upper part of FIG. 3 illustrates a network configuration of a logical layer obtained by modeling the communication network 300 with the network management information stored in the management information DB 120. In this example, the logical layer includes an optical path layer and an IP (Internet Protocol) layer. The IP layer is made redundant. The IP layer is a layer higher in order than the optical path layer. A virtual port 311C is set in the device 311, a virtual port 321C is set in the OADM 321, a virtual port 323C is set in the OADM 323, and a virtual port 313C is set in the device 313.

A network configuration of the optical path layer includes TPE entities TPE_OP1 to TPE_OP6, LC entities LC_OP1 and LC_OP2, XC entities XC_OP1 to XC_OP3, and an NC entity NC_OP1.

The TPE entities TPE_OP1 to TPE_OP6 respectively correspond to the ports 321C, 321B, 322A, 322B, 323A, and 323C. The LC entities LC_OP1 and LC_OP2 respectively correspond to connection between the OADMs 321 and 322 and connection between OADMs 322 and 323. The XC entities XC_OP1 to XC_OP3 respectively correspond to connection in the OADM 321, connection in the OADM 322, and connection in the OADM 323. The NC entity NC_OP1 corresponds to connection between the OADMs 321 and 323. The NC entity NC_OP1 is configured by the TPE entities TPE_OP1 and TPE_OP6.

A network configuration of the IP layer includes TPE entities TPE_IP1 to TPE_IP10, LC entities LC_IP1 to LC_IP4, XC entities XC_IP1 to XC_IP4, and an NC entity NC_IP1. The TPE entities TPE_IP1 to TPE_IP10 respectively correspond to the ports 311C, 311A, 311B, 321A, 321C, 323C, 323B, 313B, 313A, and 313C. The LC entities LC_IP1 to LC_IP4 respectively correspond to connection between the device 311 and the OADM 321, connection between the OADMs 321 and 323, connection between the OADM 323 and the device 313, and connection between the devices 311 and 313. The XC entity XC_IP1 corresponds to connection in the device 311 and is configured by the TPE entities TPE_IP1 to TPE_IP3. The XC entities XC_IP2 and XC_IP3 correspond to connection in the OADM 321 and connection in OADM 323. The XC entity XC_IP4 corresponds to connection in the device 313 and is configured by the TPE entities TPE_IP8 to TPE_IP10. The NC entity NC_IP1 corresponds to connection between the devices 311 and 313. The NC entity NC_IP1 is configured by the TPE entities TPE_IP1 and TPE_IP10.

It is assumed that, for example, the OADM 322 is broken down in the communication network 300. In this case, the failure-information acquisition unit 114 specifies, as a related range of failure parts, the entities NC_IP1 and LC_IP2 of the IP layer and the entities NC_OP1, XC_OP2, TPE_OP3, and TPE_OP4 of the optical path layer. Further, the failure-information acquisition unit 114 specifies, as breakdown resources, the entities NC_IP1 and LC_IP2 of the IP Layer and the entities XC_OP2, TPE_OP3, and TPE_OP4 of the optical path layer.

The communication-path retrieval unit 116 determines whether the entities NC_IP1 and NC_OP1, which are the NC entities in the related range of the failure parts, are entirely disconnected or partially path disconnected. Entirely disconnected indicates a state in which all paths are uncommunicable in a network communication section. Partially path disconnected indicates a state in which one or a plurality of paths are uncommunicable but the other paths are communicable in the network communication section. First, the communication-path retrieval unit 116 determines whether the entity NC_OP1, which is the NC entity of the optical path layer, is entirely disconnected or partially path disconnected. There is no path leading from the entity TPE_OP1 to an entity TPE_OP10 without passing through the entities XC_OP2, TPE_OP3, and TPE_OP4, which are breakdown resources. Accordingly, the communication-path retrieval unit 116 determines that the entity NC_OP1 is entirely disconnected.

Subsequently, the communication-path retrieval unit 116 determines whether the entity NC_IP1, which is the NC entity of the IP layer, is entirely disconnected or partially path disconnected. There are paths (TPE_IP1, XC_IP3, TPE_IP3, LC_IP4, TPE_IP8, XC_IP4, and TPE_IP10) leading from the entity TPE_IP1 to the entity TPE_IP10 without passing through the entity LC_IP2, which is a breakdown resource. Accordingly, the communication-path retrieval unit 116 determines that the entity NC_IP1 is partially path disconnected. As a result, the communication-path retrieval unit 116 determines that a communication section between the devices 311 and 313 is communicable.

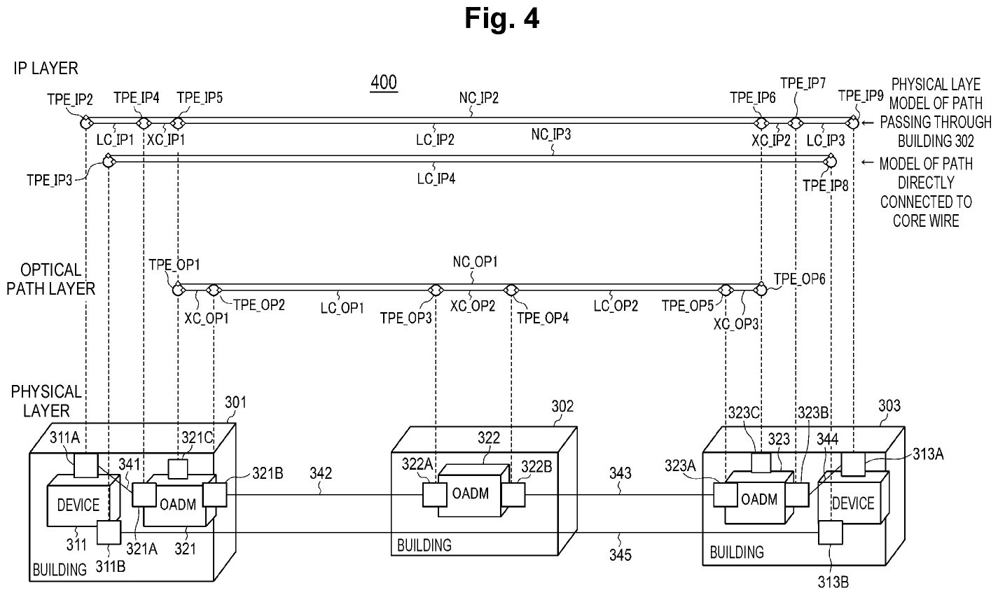

A failure influence grasping method according to related art is explained with reference to FIG. 4. In FIG. 4, the same portions as the portions shown in FIG. 3 are denoted by the same reference numerals and signs and explanation about the portions is omitted.

In the failure influence grasping method according to the related art, unlike the failure influence grasping method according to the embodiment, virtual ports are not set in the devices 311 and 313, communicability of a communication section between which is determined. In this case, in an IP layer, there is one network communication section between the devices 311 and 313. However, a network configuration including two paths, that is, a path passing through the building 302 and a path directly connected to a core wire is generated. Specifically, the network configuration of the IP layer includes TPE entities TPE_IP2 to TPE_IP9, LC entities LC_IP1 to LC_IP4, XC entities XC_IP1 to XC_IP2, and NC entities NC_IP2 and NC_IP3. Both of the NC entities NC_IP2 and NC_IP3 correspond to connection between the devices 311 and 313. An NC entity NC_OP2 is configured by the TPE entities TPE_OP2 and TPE_OP9. An NC entity NC_OP3 is configured by the TPE entities TPE_OP3 and TPE_OP8.

It is assumed that, for example, the OADM 322 is broken down in a communication network 400. In this case, the entities NC_IP2 and LC_IP2 of the IP Layer and the entities NC_OP1, XC_OP2, TPE_OP3, and TPE_OP4 of the optical path layer are specified as a related range of failure parts. Subsequently, a human operator determines communicability in the communication section between the devices 311 and 313 referring to related path information and information indicating a network configuration of a logical layer.

Accordingly, in the failure influence grasping method according to the comparative example, work operation of the operator increases and it takes time to grasp communicability in a network communication section during failure occurrence.

On the other hand, in the failure influence grasping method according to this embodiment, as explained above with reference to FIG. 3, the virtual ports 311C and 313C are respectively set in the devices 311 and 313. Consequently, the failure-influence grasping unit 110 is capable of determining communicability in the communication section between the devices 311 and 313. As a result, it is possible to reduce work operation of the operator and it is possible to quickly grasp communicability in a network communication section during failure occurrence.

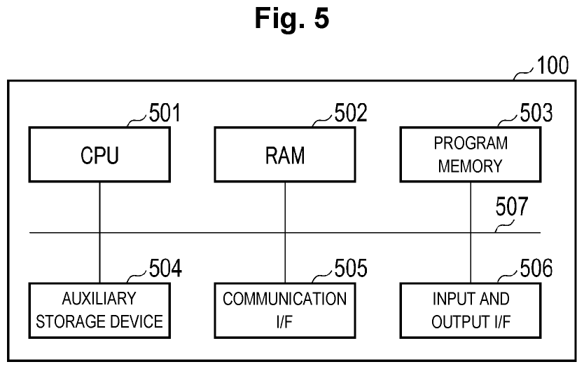

FIG. 5 illustrates an example of a hardware configuration of the network management device 100. As shown in FIG. 5, the network management device 100 includes, as hardware, a CPU (Central Processing Unit) 501, a RAM (Random Access Memory) 502, a program memory 503, an auxiliary storage device 504, a communication interface 505, an input and output interface 506, and a bus 507. The CPU 501 communicates with the RAM 502, the program memory 503, the auxiliary storage device 504, the communication interface 505, and the input and output interface 506 via the bus 507.

The CPU 501 is an example of a general-purpose hardware processor. The RAM 502 is used as a working memory by the CPU 501. The RAM 502 includes a volatile memory such as an SDRAM (Synchronous Dynamic Random Access Memory). The program memory 503 stores various programs including a failure influence determination program. As the program memory 503, for example, a ROM (Read-Only Memory), a part of the auxiliary storage device 504, or a combination of the ROM and the part of the auxiliary storage device 504 is used. The auxiliary storage device 504 stores data in a non-transitory manner. The auxiliary storage device 504 includes a nonvolatile memory such as a hard disk drive (HDD) or a solid state drive (SSD). The auxiliary storage device 504 stores data such as network management information.

The communication interface 505 is an interface for communicating with an external communication device. The communication interface 505 includes, for example, a wired LA terminal and is connected to a communication network, which can include the Internet, by a LAN cable. The input and output interface 506 includes a plurality of terminals for connecting an input device and an output device. Examples of the input device include a keyboard, a mouse, and a microphone. Examples of the output device include a display device and a speaker.

The programs stored in the program memory 503 include computer-executable instructions. When the programs (the computer-executable instructions) are executed by the CPU 501, the programs cause the CPU 501 to execute predetermined processing. For example, when the failure influence determination program is executed by the CPU 501, the failure influence determination program causes the CPU 501 to execute a series of processing explained concerning the failure-influence grasping unit 110.

The programs may be provided to the network management device 100 in a state in which the programs are stored in a computer-readable storage medium. In this case, for example, the network management device 100 further includes a drive (not shown) that reads out data from the storage medium. The network management device 100 acquires the programs from the storage medium. Examples of the storage medium include a magnetic disk, an optical disk (CD-ROM, CD-R, DVD-ROM, DVD-R, or the like), a magneto-optical disk (MO or the like), and a semiconductor memory. The programs may be stored in a server on a communication network. The network management device 100 may download the programs from the server using the communication interface 505.

Processing explained in the embodiment is not limited to be performed by the general-purpose processor such as the CPU 501 executing a program and may be performed by a dedicated processor such as an ASIC (Application Specific Integrated Circuit). The term “processing circuitry” used herein includes at least one general-purpose hardware processor, at least one dedicated hardware processor, or a combination of the at least one general-purpose hardware processor and the at least one dedicated hardware processor. In the example shown in FIG. 5, the CPU 501, the RAM 502, and the program memory 503 are equivalent to the processing circuitry.

Note that the network management device 100 is not limited to be implemented by one computer (information processing device). The network management device 100 may be implemented by a plurality of computers. For example, the network management device 100 may include a computer functioning as the modeling unit 112 and the failure-information acquisition unit 114 and a computer functioning as the communication-path retrieval unit 116 and the user specifying unit 118.

[Operation]

Subsequently, an operation example of the network management device 100 is explained. In the following explanation, it is assumed that information for specifying one or a plurality of entities such as related path information and breakdown resource information is retained as an array including one or a plurality of elements. For example, when breakdown resources are the entities LC_OP1, TPE_OP1, and TPE_OP2, the breakdown resource information is an array (LC_OP1, TPE_OP1, and TEP_OP2).

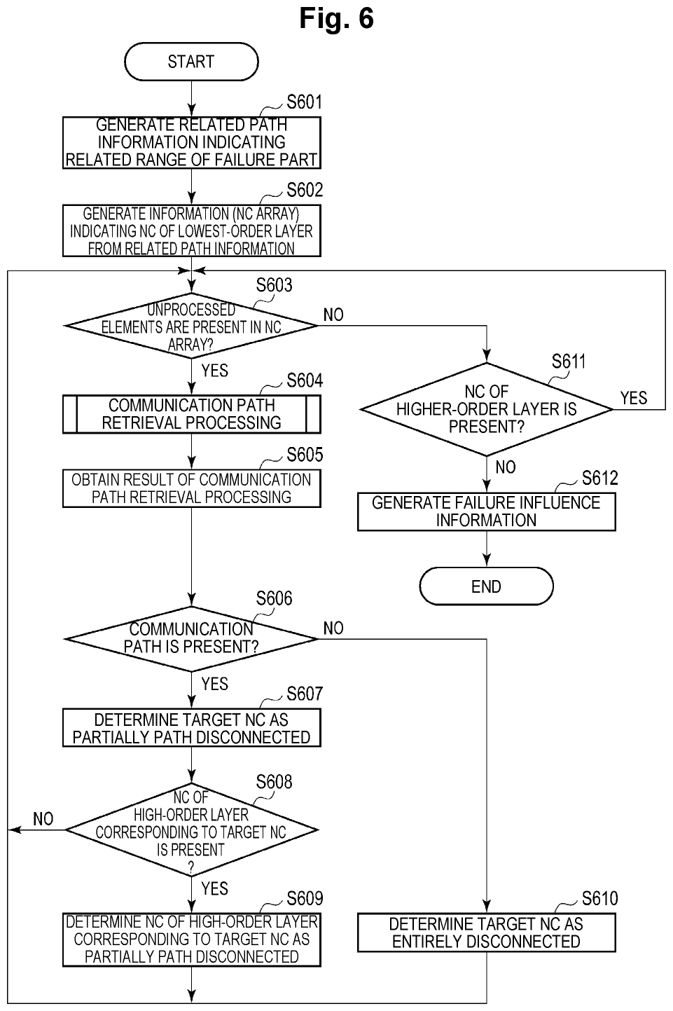

FIG. 6 shows a procedure example of a failure influence grasping method (a network management method) executed by the network management device 100 shown in FIG. 1. As shown in FIG. 6, in response to occurrence of a failure of a communication network, the failure-information acquisition unit 114 generates related path information indicating a related range of failure parts (step S601).

The communication-path retrieval unit 116 generates, from the related path information, information indicating NC entities in the lowest-order logical layer (step S602). The information indicating the NC entities represented by an array is referred to as NC array.

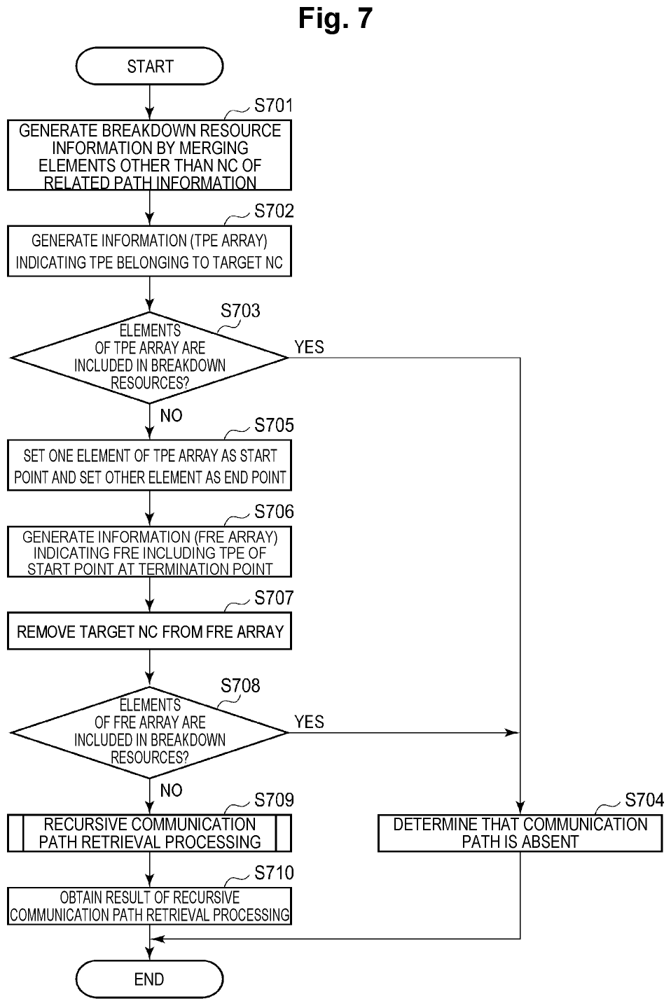

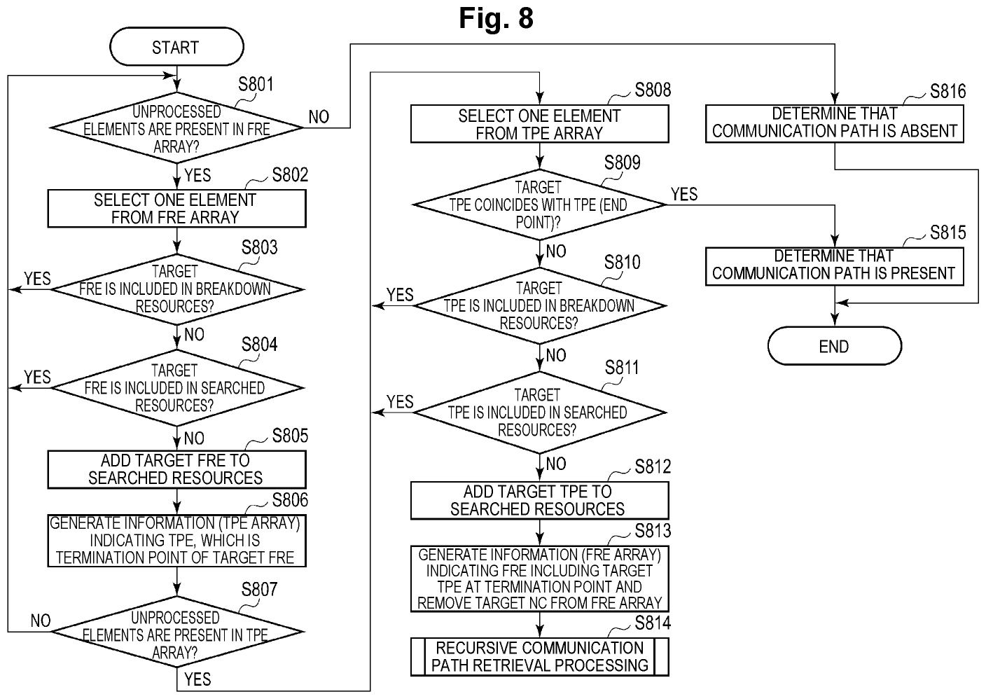

The communication-path retrieval unit 116 determines whether unprocessed elements are present in the NC array (step S603). When unprocessed elements are present (step S603; Yes), the communication-path retrieval unit 116 selects, as a target NC entity, an NC entity indicated by one unprocessed element of the NC array. The communication-path retrieval unit 116 performs communication path retrieval processing on the target NC entity (step S604). The communication path retrieval processing is explained below with reference to FIG. 7 and FIG. 8. The communication-path retrieval unit 116 obtains communication path presence or absence information, which is a result of the communication path retrieval processing (step S605).

When the communication path presence or absence information indicates communication path presence (step S606; Yes), the communication-path retrieval unit 116 determines that the target NC entity is partially path disconnected (step S607). When an NC entity of a high-order layer corresponding to the target NC entity is absent (step S608; No), the processing returns to step S603. When an NC entity of a high-order layer corresponding to the target NC entity is present (step S608; Yes), the communication-path retrieval unit 116 determines that the NC entity of the high-order layer corresponding to the target NC entity is partially path disconnected (step S609). Thereafter, the processing returns to step S603.

On the other hand, when the communication path presence or absence information indicates communication path absence (step S606; No), the communication-path retrieval unit 116 determines that the target NC entity is entirely disconnected (step S610). Thereafter, the processing returns to step S603.

When all the elements of the NC array is processed (step S603; No), the processing proceeds to step S611. The communication-path retrieval unit 116 determines, based on the related path information, whether NC entities of a higher-order logical layer are present (step S611). When NC entities of a higher-order logical layer are present (step S611; Yes), the communication-path retrieval unit 116 generates an NC array indicating the NC entities of the higher-order logical layer. The processing returns to step S603. When the example shown in FIG. 3 is referred to, after the processing ends about the optical path layer, the communication-path retrieval unit 116 generates, from the related path information, an NC array indicating NC entities of the IP layer. The communication-path retrieval unit 116 performs the processing in step S603 and subsequent steps on the NC array. However, when the NC entity determined as being partially path disconnected in step S609 is present, the communication path retrieval processing for the NC entity is omitted.

When NC entities of a higher-order logical layer are absent (step S611; No), the processing proceeds to step S612. When the example shown in FIG. 3 is referred to, the IP layer is the highest-order logical layer. After the processing ends about the IP layer, the communication-path retrieval unit 116 determines that NC entities of a higher-order logical layer is absent.

Lastly, the failure-influence grasping unit 110 generates and outputs failure influence information indicating the influence of a network failure on a service. For example, the communication-path retrieval unit 116 generates information indicating a communication section determined as being partially path disconnected and information indicating a communication section determined as being entirely disconnected. The user specifying unit 118 specifies, based on the information generated by the communication-path retrieval unit 116, users who cannot use the service and generates information indicating the number of users who cannot use the service. The failure influence information can include information generated by the communication-path retrieval unit 116 and information generated by the user specifying unit 118.

FIG. 7 and FIG. 8 show a procedure example of the communication path retrieval processing shown in step S604 in FIG. 6. As shown in FIG. 7, the communication-path retrieval unit 116 generates breakdown resource information from the related path information (step S701). For example, the communication-path retrieval unit 116 obtains breakdown resource information including an element obtained by merging elements other than elements corresponding to the NC entities of the related path information and the elements corresponding to the NC entities of the related path information.

The communication-path retrieval unit 116 specifies a TPE (TCP) entity belonging to the target NC entity and generates, as an array, information indicating the specified TPE entity (step S702). This array is referred to as TPE array.

The communication-path retrieval unit 116 determines whether elements of a TPE array are included in the breakdown resource information (step S703). When any element of the TPE array is included in the breakdown resource information (step S703; Yes), the communication-path retrieval unit 116 determines that a communication path is absent about the target NC entity and generates communication path presence or absence information indicating communication path absence (step S704). Thereafter, the processing proceeds to step S605 in FIG. 6.

On the other hand, when both of the elements of the TPE array is not included in the breakdown resource information (step S703; No), the communication-path retrieval unit 116 sets a TPE entity corresponding to one element of the TPE array as a start point and sets a TPE entity corresponding to the other element of the TPE array as an end point (step S705). Subsequently, the communication-path retrieval unit 116 specifies an FRE entity including the TPE entity of the start point at a termination point and generates information indicating the specified FRE entity as an array (step S706). This array is referred to as FRE array. The communication-path retrieval unit 116 removes elements corresponding to NC entities from the FRE array (step S707).

The communication-path retrieval unit 116 determines whether elements of the FRE array are included in the breakdown resource information (step S708). When elements of the FRE array are included in the breakdown resource information (step S708; Yes), the communication-path retrieval unit 116 determines that a communication path is absent about the target NC entity and generates communication path presence or absence information indicating communication path absence (step S704). Thereafter, the processing proceeds to step S605 in FIG. 6.

On the other hand, when elements of the FRE array is not included in the breakdown resource information (step S708; No), the communication-path retrieval unit 116 adds the elements of the FRE array to searched resource information and performs recursive communication path retrieval processing (step S709). The recursive communication path retrieval processing is explained below with reference to FIG. 8. When communication path presence or absence information is generated as a result of the recursive communication path retrieval processing, the processing proceeds to step S605 in FIG. 6.

As shown in FIG. 8, the communication-path retrieval unit 116 determines whether unprocessed elements are present in the FRE array (step S801). When unprocessed elements are present in the FRE array (step S801; Yes), the communication-path retrieval unit 116 selects an FRE entity corresponding to one unprocessed element of the FRE array (step S802). The selected FRE entity is referred to as target FRE entity. The communication-path retrieval unit 116 determines whether the target FRE entity is included in breakdown resources (step S803). When the target FRE entity is included in the breakdown resources (step S803; Yes), the processing returns to step S801.

When the target FRE entity is not included in the breakdown resources (step S803; No), the communication-path retrieval unit 116 determines whether the target FRE entity is included in searched resources (step S804). When the target FRE entity is included in the searched resources (step S804; Yes), the processing returns to step S801.

When the target FRE entity is not included in the searched resources (step S804; No), the communication-path retrieval unit 116 adds the target FRE entity to the searched resources (step S805). The communication-path retrieval unit 116 adds information indicating the target FRE entity to the searched resource information.

Subsequently, the communication-path retrieval unit 116 specifies a TPE entity, which is a termination point of the target FRE entity, and generates information indicating the specified TPE entity as an array (step S806). The communication-path retrieval unit 116 determines whether unprocessed elements are present in the TPE array obtained in step S806 (step S807). When unprocessed elements are absent (step S807; No), the processing returns to step S801.

When unprocessed elements are present (step S807; Yes), the communication-path retrieval unit 116 selects, as a target TPE entity, a TPE entity corresponding to one unprocessed element of the TPE array (step S808). The communication-path retrieval unit 116 determines whether the target TPE entity coincides with a TPE entity of an end point (step S809). When the target TPE entity coincides with the TPE entity of the end point (step S809; Yes), the communication-path retrieval unit 116 determines that a communication path is present about the target NC entity (step S815). Thereafter, the processing proceeds to step S605 in FIG. 6.

On the other hand, when the target TPE entity does not coincide with the TPE entity of the end point (step S809; No), the communication-path retrieval unit 116 determines whether the target TPE entity is included in breakdown resources (step S810). When the target TPE entity is included in the breakdown resources (step S810; Yes), the processing returns to step S807.

When the target TPE entity is not included in the breakdown resources (step S810; No), the communication-path retrieval unit 116 determines whether the target TPE entity is included in the searched resources (step S811). When the target TPE entity is included in the searched resources (step S811; Yes), the processing returns to step S805.

When the target TPE entity is not included in the searched resources (step S811; No), the communication-path retrieval unit 116 adds the target TPE entity to the searched resources (step S812). Subsequently, the communication-path retrieval unit 116 specifies an FRE entity including the target TPE entity at a termination point, generates information indicating the specified FRE entity as an array, and removes an element corresponding to the target NC entity from the array (step S813).

The communication-path retrieval unit 116 performs the recursive communication path retrieval processing on the FRE array obtained in step S813 (step S814). That is, the communication-path retrieval unit 116 performs the processing in step S801 and subsequent steps on the FRE array obtained in step S813.

The failure influence grasping processing explained above concerning FIG. 6 to FIG. 8 is explained with reference to specific examples.

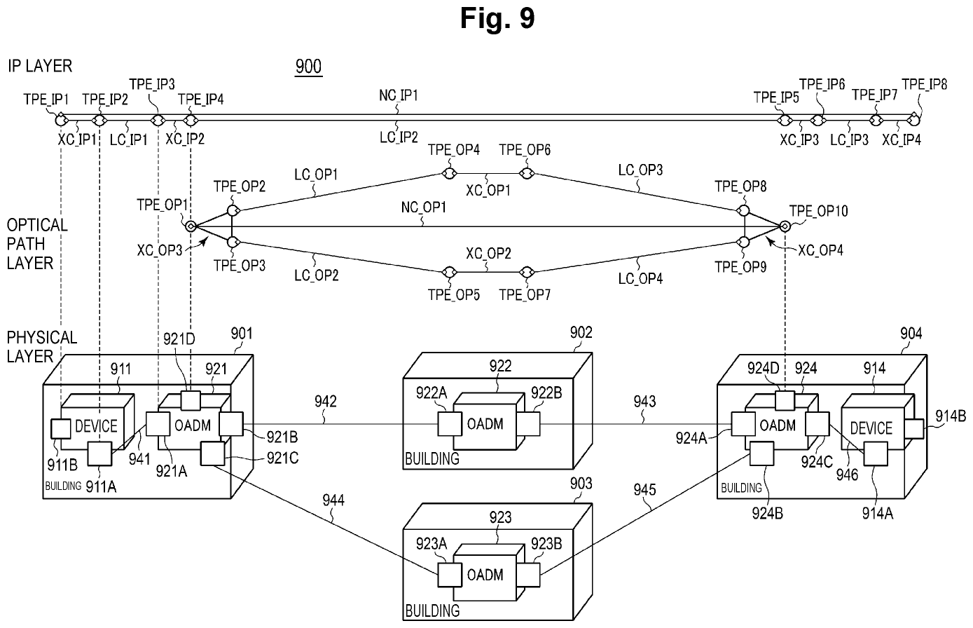

FIG. 9 illustrates the configuration of a communication network 900 according to the embodiment. The communication network 900 shown in FIG. 9 is an example of the communication network 150 shown in FIG. 1. In this example, a network of an optical path layer is made redundant.

As shown in FIG. 9, the communication network 900 includes devices 911 and 914, OADMs 921 to 924, and cables 941 to 946. The device 911 and the OADM 921 are housed in a building 901, the OADM 922 is housed in a building 902, the OADM 923 is housed in a building 903, and the device 914 and the OADM 924 are housed in a building 904. The cables 941 and 946 are, for example, LAN cables. The cables 942 to 945 are, for example, optical path cables.

The device 911 includes a physical port 911A. The device 914 includes a physical port 914A. The OADM 921 includes physical ports 921A, 921B, and 921C. The OADM 922 includes physical ports 922A and 922B. The OADM 923 includes physical ports 923A and 923B. The OADM 924 includes physical ports 924A, 924B, and 924C. The physical port 911A of the device 911 is connected to the physical port 921A of the OADM 921 by the cable 941. The physical port 921B of the OADM 921 is connected to the physical port 922A of the OADM 922 by the cable 942. The physical port 922B of the OADM 922 is connected to the physical port 924A of the OADM 924 by the cable 943. The physical port 921C of the OADM 921 is connected to the physical port 923A of the OADM 923 by the cable 944. The physical port 923B of the OADM 923 is connected to the physical port 924B of the OADM 924 by the cable 945. The physical port 924C of the OADM 924 is connected to the physical port 914A of the device 914 by the cable 946.

A virtual port 911B is set in the device 911. A virtual port 914B is set in the device 914. A virtual port 921D is set in the OADM 921. A virtual port 924D is set in the OADM 924.

A network configuration of the optical path layer includes TPE entities TPE_OP1 to TPE_OP10, LC entities LC_OP1 to LC_OP4, XC entities XC_OP1 to XC_OP4, and the NC entities NC_OP1.

The TPE entities TPE_OP1 to TPE_OP10 respectively correspond to the ports 921D, 921B, 921C, 922A, 923A, 922B, 923B, 924A, 924B, and 924D. The LC entities LC_OP1 to LC_OP4 respectively correspond to connection between the OADMs 921 and 922, connection between the OADMs 921 and 923, connection between the OADMs 922 and 924, and connection between the OADMs 923 and 924. The XC entities XC_OP1 to XC_OP4 respectively correspond to connection in the OADM 922, connection in the OADM 923, connection in the OADM 921, and connection in the OADM 924. For example, the XC entity XC_OP3 is configured by the TPE entities TPE_OP1, TPE_OP2, and TPE_OP3. The NC entity NC_OP1 indicates end-to-end connectivity in the optical path layer. The NC entity NC_OP1 corresponds to connection between OADMs 921 and 924 and is configured by the TPE entities TPE_OP1 and TPE_OP10.

A network configuration of the IP layer includes the TPE entities TPE_IP1 to TPE_IP8, the LC entities LC_IP1 to LC_IP3, the XC entities XC_IP1 to XC_IP4, and the NC entity NC_IP1. The TPE entities TPE_IP1 to TPE_IP8 respectively correspond to the ports 911B, 911A, 921A, 921D, 924D, 924C, 914A, and 914B. The LC entities LC_IP1 to LC_IP3 respectively correspond to connection between the device 911 and the OADM 921, connection between the OADMs 921 and 924, and connection between the OADM 924 and the device 914. The XC entities XC_IP1 to XC_IP4 respectively correspond to connection in the device 911, connection in the OADM 921, connection in the OADM 924, and connection in the device 914. The NC entity NC_IP1 indicates end-to-end connectivity in the IP layer. The NC entity NC_IP1 corresponds to connection between devices 911 and 914 and is configured by the TPE entities TPE_IP1 and TPE_IP10.

It is assumed that the OADM 922 in the building 902 is broken down in the communication network 900. In this case, failure parts are the OADM 922 and the ports 922A and 922B. A related range of the failure parts is the entities NC_IP1 and LC_IP2 of the IP layer and the entities XC_OP1, NC_OP1, TPE_OP4, and TPE_OP6 of the optical path layer. Accordingly, an array (NC_IP1, LC_IP2, XC_OP1, NC_OP1, TPE_OP4, and TPE_OP6) is obtained as related path information. Breakdown resources are the entities LC_IP2, XC_OP1, TPE_OP4, and TPE_OP6. Accordingly, an array (NC_IP1, LC_IP2, NC_OP1, XC_OP1, TPE_OP4, and TPE_OP6) is obtained as breakdown resource information.

In the related range of the failure parts, an NC entity of the optical path layer is the entity NC_OP1. Accordingly, first, the entity NC_OP1 is selected as a target NC entity. TPE entities belonging to the target NC entity are the entities TPE_OP1 and TPE_OP10. Accordingly, a TPE array (TPE_OP1, TPE_OP10) is obtained.

Both of TPE_OP1 and TPE_OP10, which are a first element and a second element of the TPE array, are not included in the breakdown resource information. Therefore, for example, the entity TPE_OP1 is set as a start point and the entity TPE_OP10 is set as an end point. TPE_OP1 is added to the searched resource information. The searched resource information changes to an array (TPE_OP1).

FRE entities including the entity TPE_OP1 of the start point at a termination point are the entities NC_OP1 and XC_OP3. Accordingly, an FRE array (NC_OP1, XC_OP3) is obtained. An element corresponding to the target NC entity is removed. The FRE array changes to an array (XC_OP3). XC_OP3, which is a first element of the FRE array, is not included in the breakdown resource information and is not included in the searched resource information either. Accordingly, XC_OP3 is added to the searched resource information. The searched resource information changes to an array (TPE_OP1, XC_OP3).

Termination points of the entity XC_OP3 are the entities TPE_OP1, TPE_OP2, and TPE_OP3. Accordingly, a TPE array (TPE_OP1, TPE_OP2, TPE_OP3) is obtained. TPE_OP1, which is a first element of the TPE array, does not coincide with the end point (TPE_OP10) and is not included in the breakdown resource information but is included in the searched resource information. TPE_OP2, which is a second element of the TPE array, does not coincide with the end point and is not included in the breakdown resource information and is not included in the searched resource information. Accordingly, TPE_OP2 is added to the searched resource information. The searched resource information changes to an array (TPE_OP1, XC_OP3, TPE_OP2).

FRE entities including the TPE entity TPE_OP2 at termination points are the entities XC_OP3 and LC_OP1. Accordingly, an FRE array (XC_OP3, LC_OP1) is obtained. XC_OP3, which is a first element of the FRE array, does not coincide with the end point and is not included in the breakdown resource information but is included in the searched resource information. LC_OP1, which is a second element of the FRE array, is not included in the breakdown resource information and is not included in the searched resource information. Accordingly, LC_OP1 is added to the searched resource information. The searched resource information changes to an array (TPE_OP1, XC_OP3, TPE_OP2, LC_OP1).

Termination points of the entity LC_OP1 are the entities TPE_OP2 and TPE_OP4. Accordingly, a TPE array (TPE_OP2, TPE_OP4) is obtained. TPE_OP2, which is a first element of the TPE array, does not coincide with the end point and is not included in the breakdown resource information but is included in the searched resource information. TPE_OP4, which is a second element of the TPE array, does not coincide with the end point but is included in the breakdown resource information. Consequently, it is grasped that there is no communicable path passing through the building 902.

In the TPE array (TPE_OP1, TPE_OP2, TPE_OP3) described above, a third element remains unprocessed. Accordingly, TPE_OP3, which is the third element of the TPE array, is processed. TPE_OP3 does not coincide with the end point and is not included in the breakdown resource information and is not included in the searched resource information. Accordingly, TPE_OP3 is added to the searched resource information. The searched resource information changes to an array (TPE_OP1, XC_OP3, TPE_OP2, LC_OP1, TPE_OP3).

FRE entities including the TPE entity TPE_OP3 at termination points are the entities XC_OP3 and LC_OP2. Accordingly, an FRE array (XC_OP3, LC_OP2) is obtained. XC_OP3, which is a first element of the FRE array, is included in the searched resource information. LC_OP2, which is a second element of the FRE array, is not included in the breakdown resource information and is not included in the searched resource information. Accordingly, LC_OP2 is added to the searched resource information. The searched resource information changes to an array (TPE_OP1, XC_OP3, TPE_OP2, LC_OP1, TPE_OP3, LC_OP2).

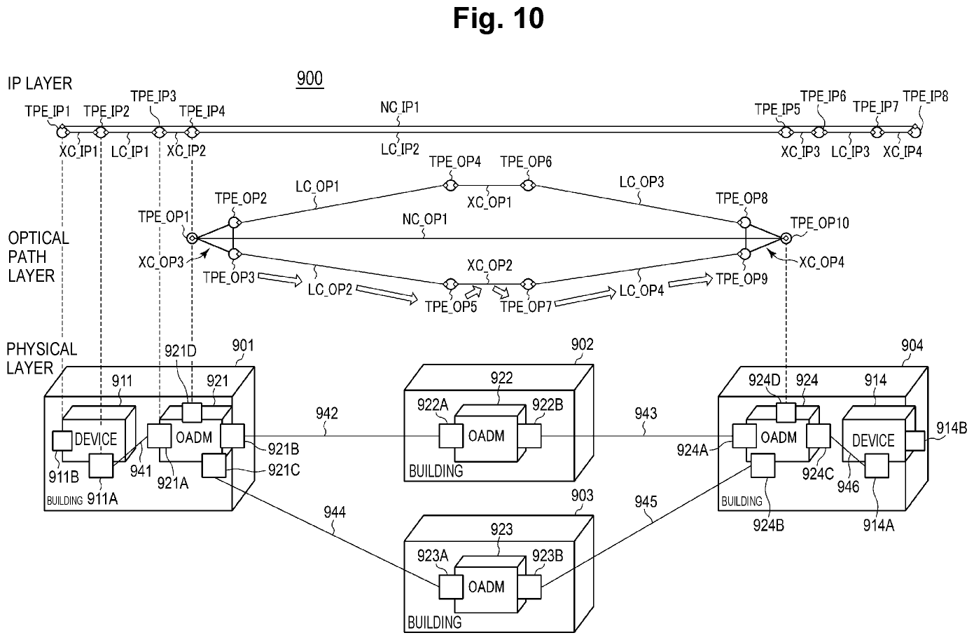

After the recursive communication path retrieval processing is repeated as indicated by arrows in FIG. 10, a TPE array (TPE_OP8, TPE_OP9, TPE_OP10) is obtained. TPE_OP10, which is a third element of the TPE array, coincides with the end point. Consequently, it is confirmed that there is a communicable path passing through the building 903. Communication path presence or absence information indicating communication path presence about the NC entity NC_OP1 is obtained as a result of the communication path retrieval processing.

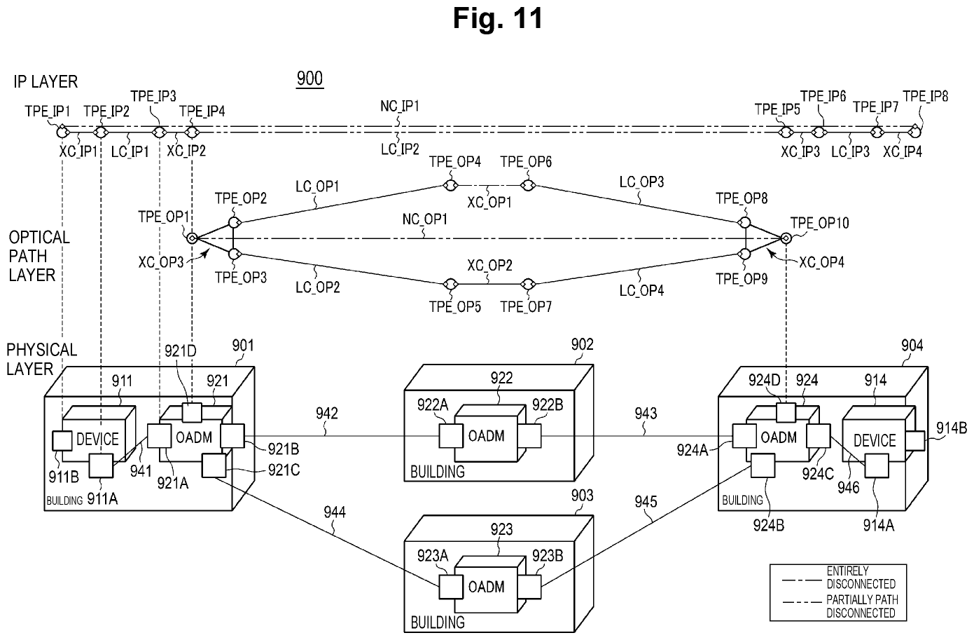

Since the communication path presence or absence information concerning the NC entity NC_OP1 indicates communication path presence, the NC entity NC_OP1 is determined as partially path disconnected. Further, the entities NC_IP1 and LC_IP2 of the IP layer corresponding to the NC entity NC_OP1 are also determined as partially path disconnected. As a result, a communication section between the devices 911 and 914 is determined as communicable. Lastly, as shown in FIG. 11, the entity XC_OP1 is determined as entirely disconnected. The entities NC_IP1, LC_IP2, and NC_OP1 are determined as partially path disconnected.

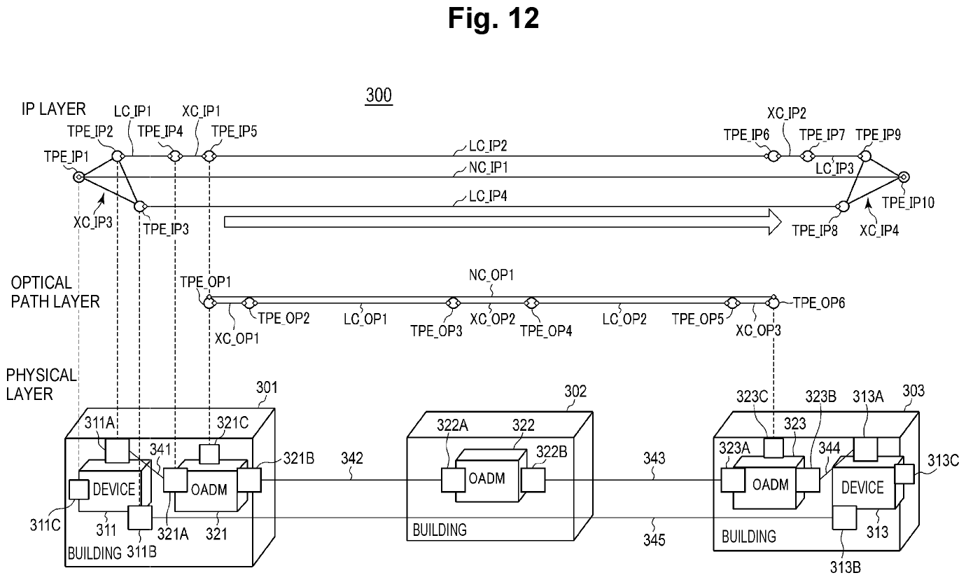

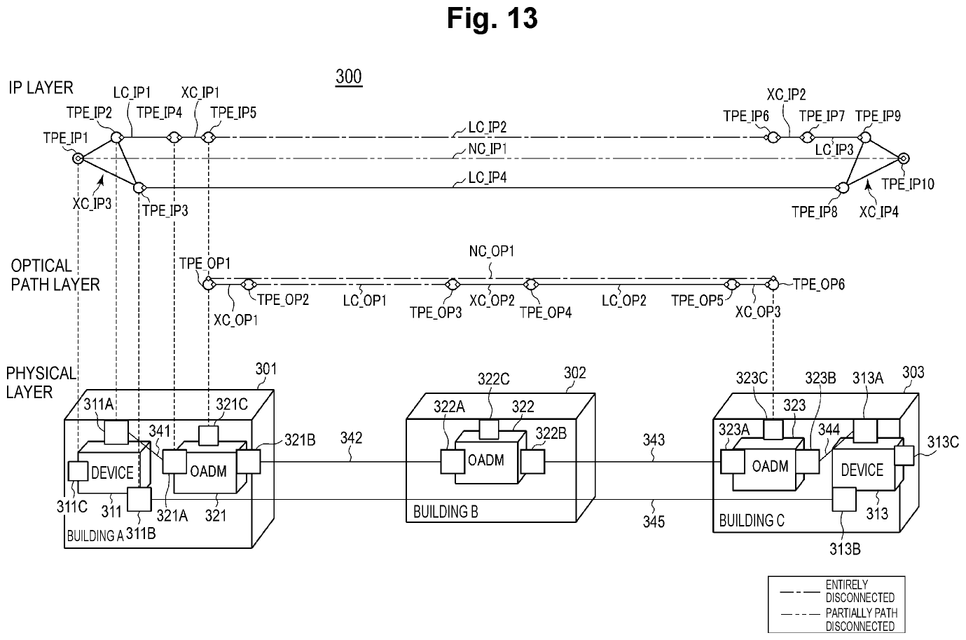

Subsequently, failure influence determination processing in the case in which a network of the IP layer is made redundant is explained with reference to FIG. 3, FIG. 12, and FIG. 13.

It is assumed that the cable 342 between the buildings 301 and 302 is ruptured in the communication network 300 shown in FIG. 3. In this case, an array (NC_IP1, LC_IP2, NC_OP1, LC_OP1, TPE_OP2, TPE_OP3) is obtained as the related path information. Further, an array (NC_IP1, LC_IP2, NC_OP1, LC_OP1, TPE_OP2, TPE_OP3) is obtained as the breakdown resource information.

First, communication path retrieval processing is performed on the entity NC_OP1, which is an NC entity of the optical path layer included in a related range of failure parts. In a process of the communication path retrieval processing on the entity NC_OP1, it is detected that the entity TPE_OP2, which is a termination point of the entity XC_OP1, is included in breakdown resources. The recursive communication path retrieval processing ends about all elements of the obtained arrays. Accordingly, communication path presence or absence information indicating communication path absence is generated about the entity NC_OP1. According to the communication path presence or absence information, the entity NC_OP1 is determined as entirely disconnected.

Subsequently, the communication path retrieval processing is performed on the entity NC_IP1, which is an NC entity of the IP layer corresponding to the entity NC_OP1. First, in a process of the recursive communication path retrieval processing on a path (TPE_IP2, LC_IP1, TPE_IP4 . . . ) passing through the building 302, it is detected that the entity LC_IP2 is included in breakdown resources. Consequently, it is determined that there is no communicable path passing through the building 302. Subsequently, as indicated by an arrow in FIG. 12, the recursive communication path retrieval processing is performed on a core wire direct connection path (TPE_IP3, LC_IP4, TPE_IP8). In a process of the recursive communication path retrieval processing on the core wire direct connection path, the entity TPE_OP10, which is a termination point of the entity XC_IP4, coincides with a TPE entity of an end point. Therefore, it is determined that a communication path is present about the core wire direct connection path. Accordingly, communication path presence or absence information indicating communication path presence about the entity NC_IP1 is generated. As a result, the entity NC_IP1 is determined as partially path disconnected. The communication section between the devices 311 and 313 is determined as communicable. Lastly, as shown in FIG. 13, the entities NC_OP1, XC_OP1, and LC_IP2 are determined as entirely disconnected. The entity NC_IP1 is determined as partially path disconnected.

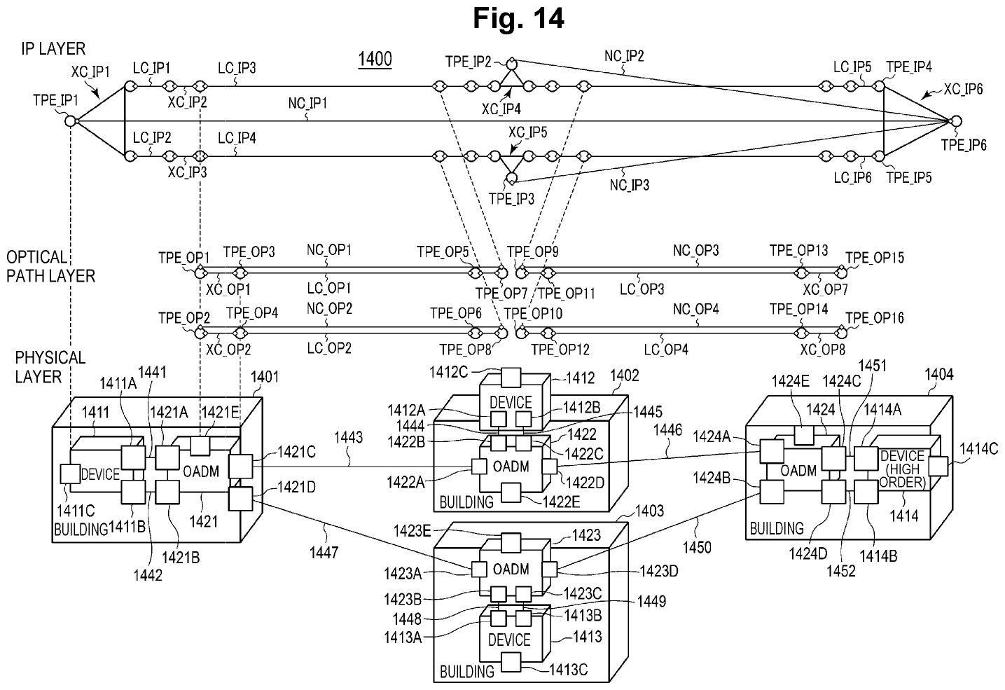

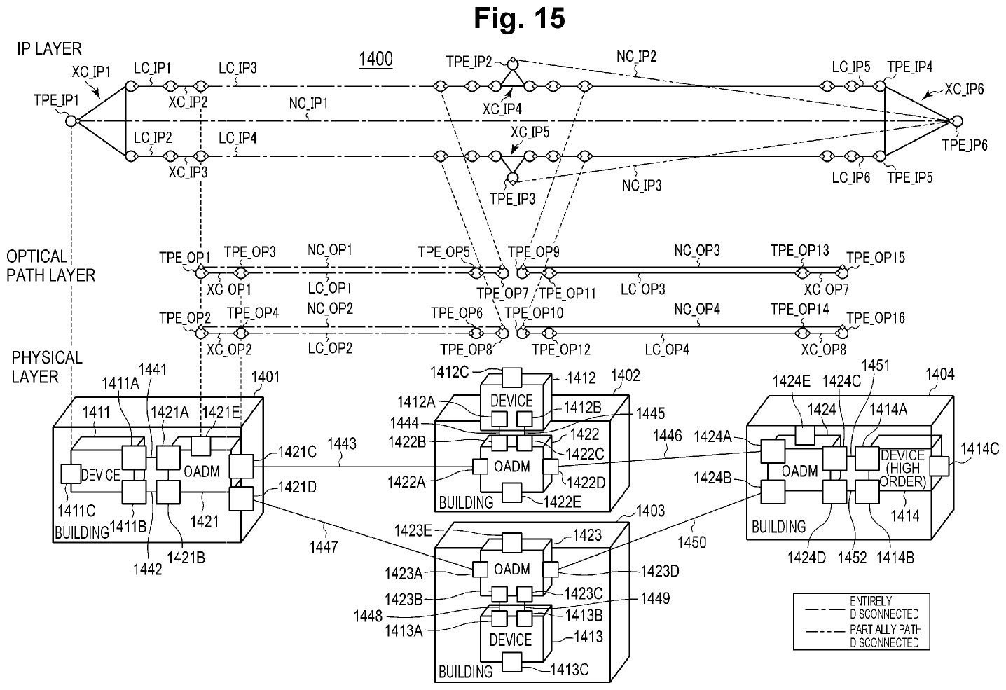

The failure influence determination processing in the case in which a network is made redundant in a ring is explained with reference to FIG. 14 and FIG. 15.

FIG. 14 illustrates the configuration of a communication network 1400 according to the embodiment. As shown in FIG. 14, the communication network 1400 includes devices 1411 to 1414, OADMs 1421 to 1424, and cables 1441 to 1452. The device 1411 and the OADM 1421 are housed in a building 1401, the device 1412 and the OADM 1422 are housed in a building 1402, the device 1413 and the OADM 1423 are housed in a building 1403, and the device 1414 and the OADM 1424 are housed in a building 1404. The cables 1441, 1442, 1444, 1445, 1448, 1449, 1451, and 1452 are, for example, LAN cables. The cables 1443, 1446, 1447, and 1450 are, for example, optical path cables.

Physical ports 1411A and 1411B of the device 1411 are respectively connected to physical ports 1421A and 1421B of the OADM 1421 by the cables 1441 and 1442. A physical port 1421C of the OADM 1421 is connected to a physical port 1422A of the OADM 1422 by the cable 1443. Physical ports 1422B and 1422C of the OADM 1422 are connected to physical ports 1412A and 1412B of the device 1412 by the cables 1444 and 1445. A physical port 1422D of the OADM 1422 is connected to a physical port 1424A of the OADM 1424 by the cable 1446. A physical port 1421D of the OADM 1421 is connected to a physical port 1423A of the OADM 1423 by the cable 1447. Physical ports 1423B and 1423C of the OADM 1423 are connected to physical ports 1413A and 1413B of the device 1413 by the cables 1448 and 1449. A physical port 1423D of the OADM 1422 is connected to a physical port 1424B of the OADM 1424 by the cable 1450. Physical ports 1424C and 1424D of the OADM 1424 are connected to physical ports 1414A and 1414B of the device 1414 by the cables 1451 and 1452.

Virtual ports 1411C to 1414C are respectively set in the devices 1411 to 1414. Virtual ports 1421E to 1421E are respectively set in the OADMs 1421 to 1424.

A network configuration of the optical path layer includes TPE entities TPE_OP1 to TPE_OP16, LC entities LC_OP1 to LC_OP4, XC entities XC_OP1 to XC_OP8, and NC entities NC_OP1 to NC_OP4.

The TPE entities TPE_OP1 and TPE_OP2 correspond to the virtual port 1421E of the OADM 1421. The TPE entities TPE_OP3 to TPE_OP6 respectively correspond to the physical ports 1421C, 1421D, 1422A, and 1423A. The TPE entities TPE_OP7 and TPE_OP9 correspond to the virtual port 1422E of the OADM 1422. The TPE entities TPE_OP8 and TPE_OP10 correspond to the virtual port 1423E of the OADM 1423. The TPE entities TPE_OP11 to TPE_OP14 respectively correspond to the physical ports 1422D, 1423D, 1424A, and 1424B. The TPE entities TPE_OP15 and TPE_OP16 correspond to the virtual port 1424E of the OADM 1424.

The LC entities LC_OP1 to LC_OP4 respectively correspond to connection between the OADMs 1421 and 1422, connection between the OADMs 1421 and 1423, connection between the OADMs 1422 and 1424, and connection between the OADMs 1423 and 1424. The XC entities XC_OP1 and XC_OP2 correspond to connection in the OADM 1421. The XC entity XC_OP1 is configured by the entities TPE_OP1 and TPE_OP3. The XC entity XC_OP2 is configured by the entities TPE_OP2 and TPE_OP4. The XC entities XC_OP3 and XC_OP5 correspond to connection in the OADM 1422. The XC entity XC_OP3 is configured by the entities TPE_OP5 and TPE_OP7. The XC entity XC_OP5 is configured by the entities TPE_OP9 and TPE_OP11. The XC entities XC_OP4 and XC_OP6 correspond to connection in the OADM 1423. The XC entity XC_OP5 is configured by the entities TPE_OP6 and TPE_OP8. The XC entity XC_OP6 is configured by the entities TPE_OP10 and TPE_OP12. The XC entities XC_OP7 and XC_OP8 correspond to connection in the OADM 1424. The XC entity XC_OP7 is configured by the entities TPE_OP13 and TPE_OP15. The XC entity XC_OP8 is configured by the entities TPE_OP14 and TPE_OP16.

The NC entity NC_OP1 corresponds to connection between the OADMs 1421 and 1422 and is configured by the TPE entities TPE_OP1 and TPE_OP7. The NC entity NC_OP2 corresponds to connection between the OADMs 1421 and 1423 and is configured by the TPE entities TPE_OP2 and TPE_OP8. The NC entity NC_OP3 corresponds to connection between OADMs 1422 and 1424 and is configured by the TPE entities TPE_OP9 and TPE_OP15. The NC entity NC_OP4 corresponds to connection between the OADMs 1423 and 1424 and is configured by the TPE entities TPE_OP10 and TPE_OP16.

A network configuration of the IP layer includes the TPE entities TPE_IP1 to TPE_IP6, the LC entities LC_IP1 to LC_IP6, the XC entities XC_IP1 to XC_IP6, and the NC entities NC_IP1 to NC_IP3. In the IP layer, for simplification of explanation, a part of entities are denoted by reference signs and are explained.

The TPE entities TPE_IP1, TPE_IP2, TPE_IP3, and TPE_IP6 respectively correspond to the virtual port 1411C of the device 1411, the virtual port 1412C of the device 1412, the virtual port 1413C of the device 1413, and the virtual port 1414C of the device 1414. The TPE entities TPE_IP4 and TPE_IP5 respectively correspond to the physical ports 1414A and 1414B of the device 1414.

The LC entities LC_IP1 and LC_IP2 correspond to connection between the device 1411 and the OADM 1421. The LC entity LC_IP3 correspond to connection between the OADMs 1421 and 1422. The LC entity LC_IP4 corresponds to connection between the OADMs 1421 and 1423. The LC entities LC_IP5 and LC_IP6 correspond to connection between the OADM 1424 and the device 1414.

The XC entity XC_IP1 corresponds to connection in the device 1411. The XC entities XC_IP2 and XC_IP3 correspond to connection in the OADM 1421. The XC entity XC_IP4 corresponds to connection in the device 1412. The XC entity XC_IP4 corresponds to connection in the device 1413. The XC entity XC_IP6 corresponds to connection in the device 1414.

The NC entity NC_IP1 corresponds to connection between the device 1414 and the device 1411 set high in order using parameters and is configured by the TPE entities TPE_IP1 and TPE_IP6. The NC entity NC_IP2 corresponds to connection between the device 1414 and the device 1412 and is configured by the TPE entities TPE_IP2 and TPE_IP6. The NC entity NC_IP3 corresponds to connection between the device 1414 and the device 1413 and is configured by the TPE entities TPE_IP3 and TPE_IP6.

It is assumed that a breakdown of the cable 1443 between the buildings 1401 and 1402 and the cable 1447 between the buildings 1401 and 1403 occurs in the communication network 1400. In this case, an array (NC_IP1, NC_IP2, NC_IP3, LC_IP3, LC_IP4, NC_OP1, NC_OP2, LC_OP1, LC_OP2, TPE_OP3, TPE_OP4, TPE_OP5, TPE_OP6) is obtained as related path information. An array (NC_IP1, NC_IP2, NC_IP3, LC_IP3, LC_IP4, NC_OP1, NC_OP2, LC_OP1, LC_OP2, TPE_OP3, TPE_OP4, TPE_OP5, TPE_OP6) is obtained as breakdown resource information.

NC entities of the optical path layer included in a related range of failure parts are the entities NC_OP1 and NC_OP2. The communication path retrieval processing is performed on the respective entities NC_OP1 and NC_OP2. First, the entity NC_OP1 is selected as a target NC entity. Since TPE_OP3 is included in the breakdown resource information, in a process of the communication path retrieval processing on the entity NC_OP1, it is determined that a communication path is absent about the entity NC_OP1. Accordingly, the entity NC_OP1 is determined as entirely disconnected. Subsequently, the entity NC_OP2 is selected as a target NC entity. Since TPE_OP4 is included in the breakdown resource information, in a process of the communication path retrieval processing on the entity NC_OP2, it is determined that a communication path is absent about the entity NC_OP2. Accordingly, the entity NC_OP2 is determined as entirely disconnected.

NC entities of the IP layer included in a related range of failure parts are the entities NC_IP1, NC_IP2, and NC_IP3. The communication path retrieval processing is performed on the respective entities NC_IP1, NC_IP2, and NC_IP3. First, the entity NC_IP1 is selected as a target NC entity. Since LC_IP3 is included in the breakdown resource information, it is determined that a communication path is absent about a path (TPE_IP6, XC_IP6, TPE_IP4, LC_IP5, . . . , TPE_IP1) passing through the building 1402. Since LC_IP4 is included in the breakdown resource information, it is also determined that a communication path is absent about a path (TPE_IP6, XC_IP6, TPE_IP5, LC_IP6, . . . , TPE_IP1) passing through the building 1403. As a result, the entity NC_IP1 is determined as entirely disconnected.

Subsequently, the entity NC_IP2 is selected as a target NC entity. Since LC_IP3 is included in the breakdown resource information, it is determined that a communication path is absent about a path (TPE_IP6, XC_IP6, TPE_IP5, LC_IP6, . . . , LC_IP2, XC_IP1, LC_IP1, . . . , PE IP2) passing through the building 1403. On the other hand, a path (TPE_IP6, XC_IP6, TPE_IP4, LC_IP5, . . . , TPE_IP2) directly connected to the building 1402 is communicable. Accordingly, the entity NC_IP2 is determined as partially path disconnected. Subsequently, the entity NC_IP3 is selected as a target NC entity. About the entity NC_IP3, a path (TPE_IP6, XC_IP6, TPE_IP5, LC_IP6, . . . , TPE_IP3) directly connected to the building 1403 is communicable. Accordingly, the entity NC_IP3 is determined as partially path disconnected. Lastly, as shown in FIG. 15, the entities NC_IP1, LC_IP3, LC_IP4, NC_OP1, LC_OP1, NC_OP2, and LC_OP2 are determined as entirely disconnected and the entities NC_IP2 and NC_IP3 are determined as partially path disconnected. A communication section between the devices 1411 and 1414 is determined as uncommunicable. A communication section between the devices 1412 and 1414 and a communication path between the devices 1413 and 1414 are determined as communicable.

[Effects]

As explained above, the network management device 100 models, according to the network management information stored in the management information DB 120, the communication network 150 having the redundant configuration in the communication section between the first and second network devices (for example, the devices 311 and 313 shown in FIG. 3) and generates the network configuration of the logical layer including the TPE entities (for example, the entities TPE_IP1 and TPE_IP10 shown in FIG. 3) corresponding to the first and second virtual ports set in the first and second network devices. In response to occurrence of a failure of the communication network 150, the network management device 100 retrieves a communicable path leading from the first TPE entity to the second TPE entity. When a communicable path leading from the first TPE entity to the second TPE entity is present, the network management device 100 determines the communication section as partially path disconnected. When a communicable path leading from the first TPE entity to the second TPE entity is absent, the network management device 100 determines the communication section as entirely disconnected.

By performing modeling of the communication network after setting the first and second virtual ports in the first and second network devices, even when the communication section has the redundant configuration, it is possible to automatically determine communicability in the communication section. As a result, it is possible to reduce work operation of the operator and it is possible to quickly grasp communicability in the communication section during failure occurrence.

When there are a plurality of logical layers, when determining that the communication path is present about an NC entity of a low-order logical layer, the network management device 100 determines that the communication path is present about an NC entity of a high-order logical layer corresponding to the NC entity. Consequently, a data processing amount is reduced. As a result, it is possible to more quickly grasp communicability in the communication section during failure occurrence and it is possible to reduce power consumption.

The NC entity of the low-order logical layer is configured by the TPE entities (for example, the entities TPE_OP1 and TPE_OP10 shown in FIG. 9) corresponding to the third and fourth virtual ports set in the third and fourth network devices (for example, the OADMs 921 and 924 shown in FIG. 9). Consequently, when the network of the low-order logical layer is made redundant, it is possible to automatically determine presence or absence of a communication path about the NC entity of the low-order logical layer.

The network management information includes the entity classes concerning the facility housing the network devices. Consequently, it is possible to automatically grasp the influence on the network service when facility damage such as collapse of a building or rupture of a cable occurs.

This embodiment adopts the network management architecture in which the connection relation in the physical layer, the connection relation in the logical layer, and the connection relation between the layers are managed by specifications and entities. Consequently, it is possible to determine communicability considering the redundant configuration of the network irrespective of types of the physical layer and the logical layer and the numbers of communication paths in the layers.

[Modifications]

The modeling unit 112 shown in FIG. 1 is an example of a logical-layer-information acquisition unit that acquires a network configuration of a logical layer concerning the communication network 150. The network configuration of the logical layer concerning the communication network 150 may be generated by a device different from the network management device 100. The network management device 100 may acquire, with a logical-layer-information acquisition unit, information indicating the network configuration of the logical layer concerning the communication network 150.

Note that the present invention is not limited to the embodiments explained above. In an implementation stage, the present invention can be variously modified in a range not departing from the gist of the present invention. The embodiments may be combined and implemented as appropriate as much as possible. In that case, a combined effect is obtained. Further, inventions in various stages are included in the embodiments explained above. Various inventions can be extracted according to appropriate combinations in a disclosed plurality of constituent elements.

[Notes]

A part or all of the embodiments explained above can be described as indicated by the following notes but is not limited to the following.

(C1)

A network management device comprising:

a logical-layer-information acquisition unit that acquires a network configuration of a logical layer concerning a communication network having a redundant configuration in a communication section between a first network device and a second network device, the network configuration being a network configuration of a logical layer including a plurality of logical entities including a first logical entity corresponding to a first virtual port set in the first network device and a second logical entity corresponding to a second virtual port set in the second network device; and

a communication-path retrieval unit that, in response to occurrence of a failure of the communication network, retrieves a communicable path leading from the first logical entity to the second logical entity.

(C2)

The network management device according to C1, wherein

the logical layer includes a first logical layer and a second logical layer higher in order than the first logical layer,

the communication-path retrieval unit determines presence or absence of a communication path about a third logical entity indicating end-to-end connectivity in the first logical layer, when determining that the communication path is present about the third logical entity, determines that the communication path is present about a fourth logical entity corresponding to the third logical entity and indicating end-to-end connectivity in the second logical layer, and, when determining that the communication path is absent about the third logical entity, determines presence or absence of a communication path about the fourth logical entity.

(C3)

The network management device according to C2, wherein

the communication network includes a third network device and a fourth network device in the communication section, and

the third logical entity is configured by a fifth logical entity corresponding to a third virtual port set in the third network device and a sixth logical entity corresponding to a fourth virtual port set in the fourth network device.

(C4)

The network management device according to any one of C1 to C3, further comprising a failure-information acquisition unit that specifies a logical entity related to the failure among the plurality of logical entities by referring to network management information including information concerning a facility housing the network devices, wherein

the communication-path retrieval unit retrieves, based on the specified logical entity, the communicable path leading from the first logical entity to the second logical entity.

(C5)

A network management method executed by a network management device, the network management method comprising:

acquiring a network configuration of a logical layer concerning a communication network having a redundant configuration in a communication section between a first network device and a second network device, the network configuration being a network configuration of a logical layer including a plurality of logical entities including a first logical entity corresponding to a first virtual port set in the first network device and a second logical entity corresponding to a second virtual port set in the second network device; and

in response to occurrence of a failure of the communication network, retrieving a communicable path leading from the first logical entity to the second logical entity.

(C6)

The network management method according to C5, wherein

the logical layer includes a first logical layer and a second logical layer higher in order than the first logical layer,

the retrieving the communicable path leading from the first logical entity to the second logical entity includes:

determining presence or absence of a communication path about a third logical entity indicating end-to-end connectivity in the first logical layer;

when determining that the communication path is present about the third logical entity, determining that the communication path is present about a fourth logical entity corresponding to the third logical entity and indicating end-to-end connectivity in the second logical layer; and

when determining that the communication path is absent about the third logical entity, determining presence or absence of a communication path about the fourth logical entity.

(C7)

The network management method according to C5 or C6, further comprising specifying a logical entity related to the failure among the plurality of logical entities by referring to network management information including information concerning a facility housing the network devices, wherein

the retrieving the communicable path leading from the first logical entity to the second logical entity includes retrieving, based on the specified logical entity, the communicable path leading from the first logical entity to the second logical entity.

(C8)

A program for causing a computer to function as the units included in the network management device according to any one of C1 to C4.

### REFERENCE SIGNS LIST

100 Network management device
110 Failure-influence grasping unit
112 Modeling unit
114 Failure-information acquisition unit
116 Communication-path retrieval unit
118 User specifying unit
120 Management information database
122 Entity database
124 Spec database
150 Communication network
300, 400, 900, 1400 Communication network
301 to 303, 901 to 904, 1401 to 1404 Building
311, 313, 911, 914, 1411 to 1414 Device
311A, 311B, 313A, 313B, 321A to 321C, 321B to 323B, 911A, 914A, 921A to 924A, 921B to 924B, 921C, 924C, 1411A to 1414A, 1411B to 1414B, 1421A to 1424A, 1421B to 1424B, 1421C to 1424C, 1421D to 1424D Physical port
311C, 313C, 321C, 323C, 911B, 914B, 921D, 924D, 1411C to 1414C, 1421E to 1421E Virtual port
341 to 345, 941 to 946, 1441 to 1452 Cable
501 CPU
502 RAM
503 Program memory
504 Auxiliary storage device
505 Communication interface
506 Input and output interface
507 Bus

1. A network management device comprising a processing circuitry configured to perform operations comprising:
acquiring a network configuration of a logical layer concerning a communication network having a redundant configuration in a communication section between a first network device and a second network device, the network configuration being a network configuration of a logical layer including a plurality of logical entities including a first logical entity corresponding to a first virtual port set in the first network device and a second logical entity corresponding to a second virtual port set in the second network device; and
in response to occurrence of a failure of the communication network, retrieving a communicable path leading from the first logical entity to the second logical entity.

2. The network management device according to claim 1, wherein:
the logical layer includes a first logical layer and a second logical layer higher in order than the first logical layer,
retrieving the communicable path leading from the first logical entity to the second logical entity includes:
determining presence or absence of a communication path about a third logical entity indicating end-to-end connectivity in the first logical layer;
when determining that the communication path is present about the third logical entity, determining that the communication path is present about a fourth logical entity corresponding to the third logical entity and indicating end-to-end connectivity in the second logical layer; and
when determining that the communication path is absent about the third logical entity, determining presence or absence of a communication path about the fourth logical entity.

3. The network management device according to claim 2, wherein:
the communication network includes a third network device and a fourth network device in the communication section, and
the third logical entity is configured by a fifth logical entity corresponding to a third virtual port set in the third network device and a sixth logical entity corresponding to a fourth virtual port set in the fourth network device.

4. The network management device according to claim 1, wherein:
the processing circuitry further performs specifying a logical entity related to the failure among the plurality of logical entities by referring to network management information including information concerning a facility housing the network devices, and
the retrieving the communicable path leading from the first logical entity to the second logical entity includes retrieving, based on the specified logical entity, the communicable path leading from the first logical entity to the second logical entity.

5. A network management method comprising:
acquiring, by processing circuitry, a network configuration of a logical layer concerning a communication network having a redundant configuration in a communication section between a first network device and a second network device, the network configuration being a network configuration of a logical layer including a plurality of logical entities including a first logical entity corresponding to a first virtual port set in the first network device and a second logical entity corresponding to a second virtual port set in the second network device; and
in response to occurrence of a failure of the communication network, retrieving, by the processing circuitry, a communicable path leading from the first logical entity to the second logical entity.

6. The network management method according to claim 5, wherein:
the logical layer includes a first logical layer and a second logical layer higher in order than the first logical layer,
the retrieving the communicable path leading from the first logical entity to the second logical entity includes:
determining presence or absence of a communication path about a third logical entity indicating end-to-end connectivity in the first logical layer;
when determining that the communication path is present about the third logical entity, determining that the communication path is present about a fourth logical entity corresponding to the third logical entity and indicating end-to-end connectivity in the second logical layer; and
when determining that the communication path is absent about the third logical entity, determining presence or absence of a communication path about the fourth logical entity.

7. The network management method according to claim 5, further comprising specifying a logical entity related to the failure among the plurality of logical entities by referring to network management information including information concerning a facility housing the network devices,
wherein retrieving the communicable path leading from the first logical entity to the second logical entity includes retrieving, based on the specified logical entity, the communicable path leading from the first logical entity to the second logical entity.

8. A non-transitory computer-readable medium including instructions that, when executed by a hardware processor, cause the hardware processor to execute operations including:
acquiring a network configuration of a logical layer concerning a communication network having a redundant configuration in a communication section between a first network device and a second network device, the network configuration being a network configuration of a logical layer including a plurality of logical entities including a first logical entity corresponding to a first virtual port set in the first network device and a second logical entity corresponding to a second virtual port set in the second network device; and
in response to occurrence of a failure of the communication network, retrieving a communicable path leading from the first logical entity to the second logical entity.
